(19) United States
(12) Patent Application Publication
(10) Pub. No.: US 2006/0199144 A1
(43) Pub. Date: Sep. 7, 2006

(54) High Efficiency LED Curing Light System

(76) Inventors: Yongqian Liu, Richardson, TX (US); Rohit Sachdeva, Plano, TX (US)

Correspondence Address: YONGQIAN LIU, 4404 BRECKINRIDGE BLVD., RICHARDSON, TX, 75082, US

(21) Appl. No.: 10/906,772

(22) Filed: Mar. 5, 2005

(51) Int. Cl. A61C 3/00

(52) U.S. Cl. 433/29

(57) ABSTRACT

Disclosed is a dental LED curing light system for curing of dental photo-polymerization materials. The system comprises of a single LED source 310, a portable handheld body 520 with rechargeable batteries 580 and control circuit board 560, and a plurality of Fresnel lenses 321 and 541. The said LED source is powered and controlled by the circuit board and provides high power curing light in the range of 300 to 500 nm and optical power in the range of 100 to 800 mW. The said Fresnel lenses couple said curing light efficiently to a focused spot on a curing object.

### FIELD OF THE INVENTION

The invention relates generally to curing of materials with light radiation and more particularly to dental curing apparatus.

### BACKGROUND OF THE INVENTION

Photosensitive materials or adhesives are commonly used in bonding object surfaces together or for filling openings and cavities in an object surface. They are cured by exposure to radiation energy, such as UV with a wavelength of 300 to 400 nm or blue light with a wavelength of 400 to 500 nm. In the field of dentistry, curable adhesives and dental curing apparatus are common practice in restoration and cosmetic procedures using restorative materials, dental sealants and orthodontic adhesives to bond brackets to the surfaces of teeth.

Traditionally, curing light apparatus are implemented with bulk lamps such as tungsten-halogen lamps coupled into fiber optic waveguide that deliver light to expose area of adhesives need to be cured. Recent advances in light emitting diodes (LEDs) technologies have enabled a new class of curing light apparatus with smaller size, longer lifetime and lower cost by semiconductor light emitting chips.

LEDs emit light at selected wavelengths of absorption band of photo-initiators that start the curing process of curable adhesives. Typical wavelength for dental curing is in the range of 400-500 nm. It is highly desirable to have high optical density impinged on the curable adhesives to activate the photo-initiators that allow a quick curing time of between 2 to 10 seconds and a deeper curing depth of between 2 to 6 millimeters. Typically ranges of optical density for a desirable 4 to 5 millimeters curing depth and less than 10 seconds curing time are above 1000 mW/cm². Such intensity is exposed to the curing area, typically in the range of 2 to 6 mm dimension, limited by the cavity and bracket size.

There have been two approaches in the selection of LEDs to achieve such high intensity, namely single high power LEDs or multiple standard single diode LEDs. High power LEDs integrates multiple LED chips in a single package such as LEDs made by Lumiled's Luxeon product lines that generate optical power as high as 700 mW. Standard single chip LEDs generates optical power below 150 mW. Typical arrangements of more than five LEDs are required to deliver equivalent power at the curing site. Other critical elements of efficient curing are the light delivering system and working distance of the curing apparatus from the curing object for efficient cure.

U.S. Pat. No. 6,611,110 describes an apparatus using light guides to deliver curing light from a single LED to the curing site. The light guide reduces the deliverable curing light efficiency due to optic coupling, transmission, and diffraction losses from light guide with a typical total efficiency of below 30%. A higher power LED can compensate the loss. Additional use of lens such as total internal reflection (TIR) lens as described in U.S. Pat. No. 6,692,251 can improve the power density. However, they introduce higher cost and more cumbersome system. Additionally, it has been shown that autoclaving the light guide to sterilize the apparatus can reduce the transmission performance of the light guide making them costly to replace.

U.S. Pat. No. 20030133203 describes an apparatus using a bulk aspheric lens to directly focus curing light from a single LED to the curing site. The aspheric lens is molded glass or plastic lens. The benefit of such implementation is a reduced size and cost compared to using of light guide. However, a high power LED is highly non-directional typically following a Lambertian radiation pattern with radiation angles above 120 degrees at half of its maximum intensity. Combined with a source chip size of typically 1 millimeter, the LED radiation incurs collection loss through the aspheric lens and diffracts quickly to lose its intensity due to limited collection angle that aspheric lens offers, which is typically less than 70 degrees. Aspheric lens with short focal length to collect light from LED source are also thick with aspect ratio of diameter to thickness close to one enlarging the size of the apparatus as well. Working distances of such devices are typically limited to within 3 millimeters. In addition, sterilizing tubes to protect the lens entrance will significantly reduce radiation due to optical diffractions.

A need exists, therefore, for improved LED curing apparatus that provide efficient light delivery to the curing site at a minimum cost.

### SUMMARY OF THE INVENTION

Accordingly, it is a principal object of the present invention to overcome the disadvantages of prior art methods of dental curing light system. The present invention comprises a method, and resulting apparatus, for highly efficient curing system for curable materials, in particular for dental curing.

In one embodiment, the dental LED curing system includes a high power LED source. The LED is powered by rechargeable batteries through a control circuit board. The LED illumination is captured by a Fresnel lens with collection angles approximately between 100 to 160 degrees into diffraction limited collimating beam and then focused into a spot diameter approximately less than 5 millimeters by a second Fresnel lens placed in close proximity to the first lens. The exit window of the lens is protected by a sterilizable or disposable plastic cap with open diameter for illumination or an additional Fresnel lens mounted on it to further reduce the spot diameter.

It is to be understood that both the foregoing general descriptions and the following detailed description are merely exemplary of the invention, and are intended to provide an overview or framework for understanding the nature and character of the invention as it is claimed. Additional features and advantages of the invention will become apparent from the following drawings and description. The drawings illustrate various embodiments of the invention and together with the description serve to explain the principles and operations of the invention.

### BRIEF DESCRIPTION OF THE DRAWINGS

The above and further advantages of this invention may be better understood by referring to the following description taken in conjunction with the accompanying drawings in which like numerals designate corresponding elements or sections throughout, and in which:

FIG. 1 shows a prior art dental LED curing system using fiber optic guide;

FIG. 2 shows another prior dental LED curing method using a bulk aspheric lens;

FIG. 3 shows an embodiment of a LED focus method using current invention;

FIG. 4 shows curing light intensity as a function of the distance from the curing apparatus to the curing object using current invention;

FIG. 5 shows an embodiment of the dental LED curing system using the current invention;

FIG. 6 shows another embodiment of the dental LED curing system using the current invention;

### DETAILED DESCRIPTION OF THE PREFERRED EMBODIMENTS

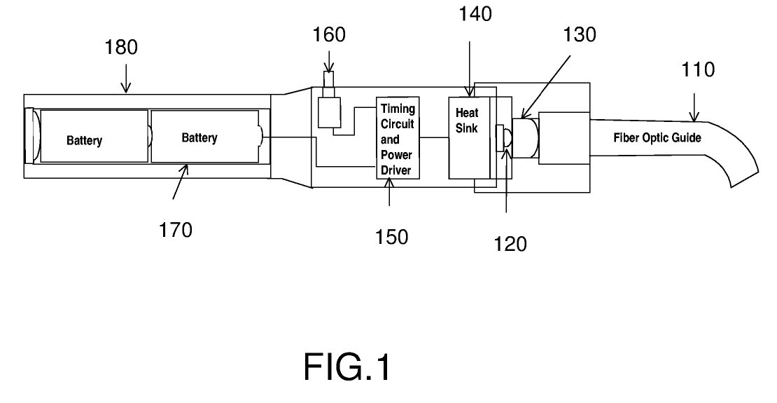

FIG. 1 illustrates a prior art dental LED curing system in a housing 180 which contains rechargeable batteries 170, drive board 150 with timing circuit and power driver, a single LED 120, heat sink 140, and fiber optic guide 11 0. The high power LED source 120 provides curing light coupled to the fiber optic guide 110 through a coupling lens 130. Typical coupling efficiencies of such free space to a light guide coupling are less than 80%. The LED light 120 is thermally managed by a heat sink 140 and electrically controlled by a circuit board that delivers the drive current and timing sequence of exposure. A plurality of rechargeable batteries 170 provide the power supply for the curing unit activated by a momentary switch 160. Fiber optic guide based high power dental LED curing lights are both more expensive and less efficient due to the incorporation of the light guide.

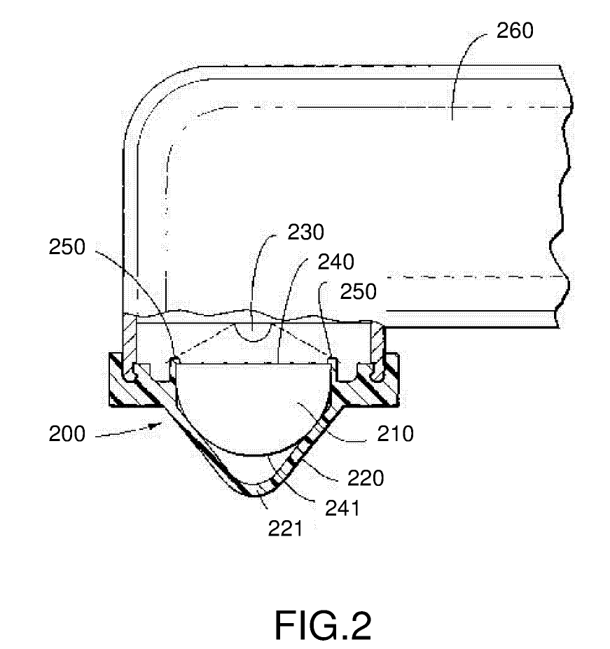

FIG. 2 shows another prior art dental LED curing light device 200 consisting of a LED 230, an aspheric lens 210, and a transparent shield 220 all attached to an extension arm 260. The aspheric lens 210 comprises of a first end 240, which is substantially flat, and a second end 241 that has an aspheric curvature. The transparent shield has an apex 221 to ease use for insertion into a dental cavity and clips 250 to wrap around and secure the lens 210 in place. The aspheric lens is preferably composed of a transparent material such as glass, aluminum dioxide, sapphire, quartz, acrylic, polyacrylic, polypropylene, and silcone. Apparatus using standard aspheric lenses as described are limited by the performances of the optical parameters of such lens with collection angle typically less than 70 degrees and thickness of more than three millimeters due to high curvature required to have short focal length. As a result, they are not efficient in focusing curing light.

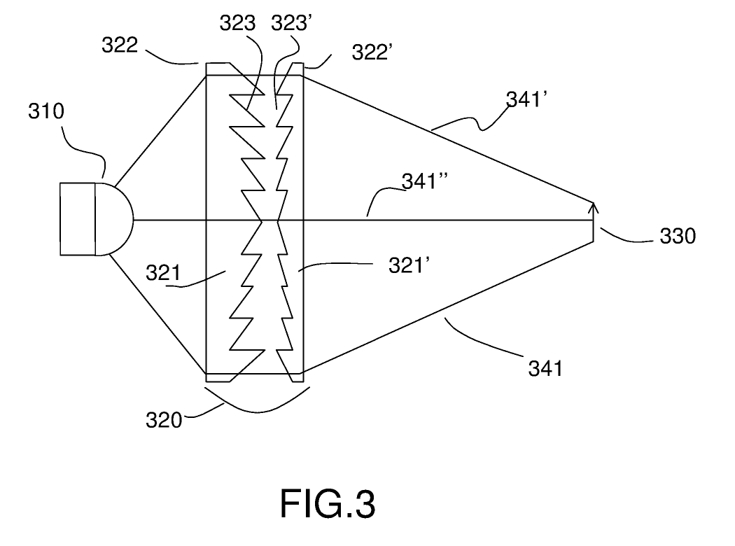

FIG. 3 illustrates an embodiment of the present invention for LED curing source consisting of a single high power LED 310 and a Fresnel lens pair 320 that focuses the illuminating light to a spot 330. The high power LED 310 preferably has an optical output power in approximately between 400-800 mW, such as Luxeon V produced by Lumiled at a wavelength in range of 400-500 nm. Higher powers are preferred since they provide faster and deeper curing. The illumination rays 341, 341′, and 341″ illustrate the function of the lens pair in collecting radiation into collimated beam and focus to a curing spot. The embodiment of the current invention enables collimation of LED illumination with minimum coupling loss, focus of the beam to a desired spot size limited by diffraction from source chip size and a minimum thickness in the lens assembly.

The Fresnel lens pair 320 acts as a condenser lens consisting of a collimating lens 321 and a focusing lens 321′. The collimating lens 321 is placed at a focal distance from the LED source 310 preferably between 2-5 millimeters to collimate the source light to a diffraction limited collimation beam. This lens should maximize collection efficiency while balancing the size limitation of the instrument. A good parameter of the lens performance is described by optical F numbers as defined in:
F number=f/D
where the F number is the ratio of the focal length of the lens divided by the beam diameter of the lens. Smaller F number provides higher collection efficiency in angular distributed radiations.

The use of Fresnel lens enables a much faster lens with the F number below 0.3 that can collect the Lambertian illumination from the LED up to 120 to 160 degrees as compared with typical aspheric lens with F number above 0.5 which collects radiation below 70 degrees. This minimizes loss during coupling as is often encountered in the fiber waveguide coupling and the aspheric lens coupling.

The focus lens 321′ is placed in close proximity parallel to the collimating lens 321 with a focal length determined by the working distance of a particular application. For dental curing applications, the focal length of the focusing lens 321′ is preferably between 2 to 20 millimeters optimizing the efficiency at a working distance of 2 to 20 millimeters. The Fresnel lens pair also effectively works as a single lens with very short focal length of below 2 millimeters and very thin thickness as small as 0.5 millimeters, which are critical to both minimizing diffraction loss and making compact devices.

The Fresnel lens consists of a groove side 323 and 323′, and a flat side 322 and 322′. The grooves are circular cylindrical portions intersected by conical portions manufactured by standard machine processes such as diamond turning, injection and compression molding. They maintain the contour of the refracting surface of a conventional lens while removing the bulk of material between the refracting surfaces.

The Fresnel lens pair 320 is preferably formed by a groove out Fresnel lens 321 and a groove in Fresnel lens 321′ bonded together to form a thin sheet lens 320 with flat outside surfaces. Such arrangement eases mounting of the Fresnel lens pair 320 into a lens cell that attaches to the LED mount in addition to improve scratch resistance to the active Fresnel groove surface. Constant groove spacing or constant groove heights can be used in the design of the Frensnel lens. Compared to bulk aspheric lens, Fresnel lens can be 10 times thinner which is critical to the application for close distance focus. Depending on the shapes of the grooves, a circular, square or narrow line focused spot can be realized at the focus spot 330 using circular or cylindrical lens.

The Fresnel lens can be made of transparent materials such as polycarbonate, acrylic, silicone, rigid vinyl and others that are low cost through compression or injection molding of large piece of materials enabling wafer level productions. The lens pair can be assembled together through standard packaging procedures such as bonding at individual on wafer level.

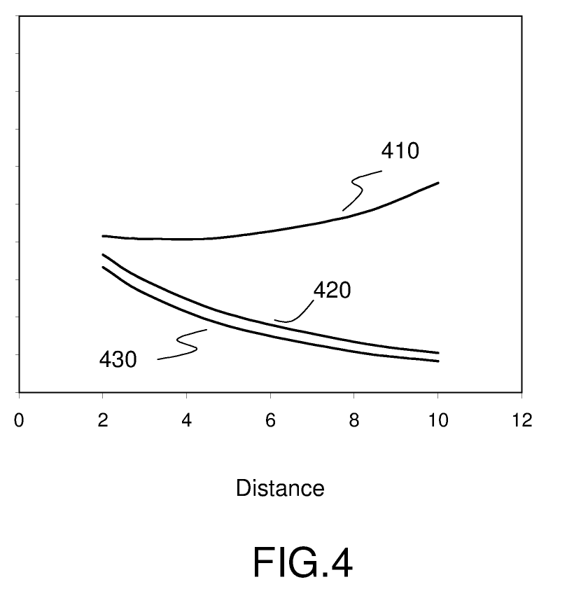

FIG. 4 compares theoretical performance of the current invention with the two prior art dental curing systems. The calculation shows the curing light intensity (power density) as a function of the distance from the output window of the curing units to the curing object. Compared with conventional curing units using fiber optic guide 430 and bulk aspheric lens 420, the current invention 410 maintains and optimizes curing intensity between 2 to 10 millimeters through minimized diffraction and optimized beam focusing. The light intensity at 10 millimeters of the current invention is more than five times that of the prior art approaches ensuring maximum curing at desired locations.

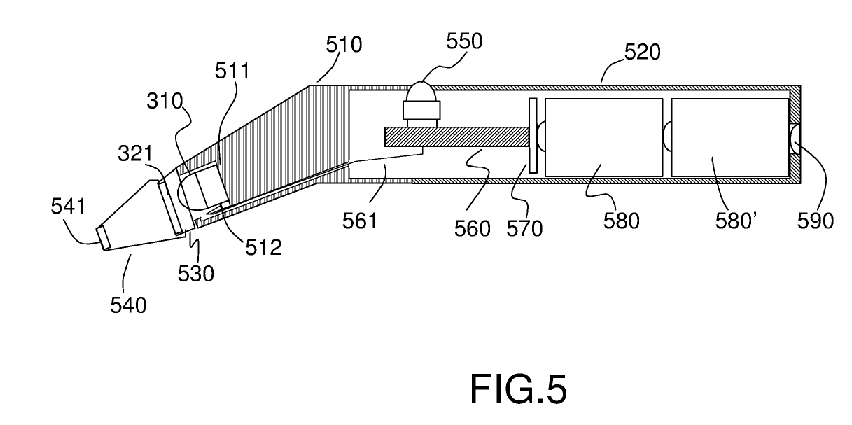

FIG. 5 illustrates an embodiment of the current invention in a high efficiency dental LED curing system consisting of a handheld body 520, an LED mounting head 510, a high power LED 310, Fresnel lens pair 321, and a sterizliable cap 540. The handheld body 520 contains a plurality of rechargeable batteries 580 and 580′, LED control drive board 560, on-off switch button 550, and drive circuit wiring 561. The batteries 580 and 580′ connect with the drive board through positive and negative terminals 570 and 590. The drive board 560 performs DC-DC conversion to the desired drive current for the LED 310 in addition to preset exposure timing sequence and thermal protection of LED against high temperatures through a thermal sensor 512 placed in close proximity to the LED. The LED head mount 510 provides heat dissipation to the LED generated powers through thermal interface 511 bonded by thermal epoxy between the back side of the LED 310 and the surface 511. The head mount 510 preferably provides an angle of illumination, approximately between 5 to 45 degrees, for ease of access to mouth. Materials for the head mount 510 are highly heat conductive. Example materials are metals such as aluminum and copper. A lens mount 530 is attached onto the head mount 510 and centered at the LED light source. The Fresnel lens pair 321 is mounted on the output side of the lens mount 530 at a distance from the LED chip that matches the focal length of the first Fresnel lens 321. A lens cap 540 snap attaches to the lens mount 530. The length of the lens cap 540 is shorter than the focal length of the second Fresnel lens 321′. The lens cap 540 provides stray light shield with proper doping of the cap materials to absorb the wavelength of the illuminated light from the LED. It can also be attached with a third Fresnel lens 541 at the exit window to further improve the working distance of the curing light. The lens cap is preferably made of materials that are disposable such as acrylic, polycarbonate and other plastics. It further provides a means to sterilize or dispose the cap at a minimum cost.

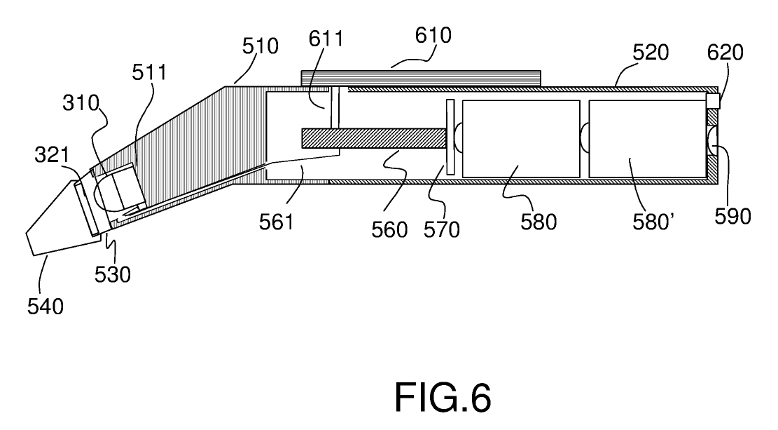

FIG. 6 illustrates a further embodiment of the present invention consisting of the handheld unit with a touch screen display 610. The touch screen display is preferably of liquid crystal displays with its drive and control circuit implemented on the drive board 560 through an electrical connection 611. Also attached is a recharging plug 620 for direct charging on a base charger.

The proposed high efficiency LED-curing system enables low cost and efficient curing of photosensitive materials. The system is particularly useful for portable handheld dental curing light. Additional add on components to the system such as digital viewing cameras chips and spectral response detectors will enable further functionalities to monitor in-vivo the status of teeth and relative curing state of the adhesives. It will be apparent to those skilled in the art that various modifications and variations can be made to the present invention without departing from the spirit and scope of the invention. Thus it is intended that the present invention covers the modifications and variations of this invention provided they come within the scope of the appended claims and their equivalents.

What is claimed is:

1. A dental curing light apparatus comprising:
a. a LED source;
b. means of powering up said LED source to emit curing light;
c. a plurality of Fresnel lenses to deliver said emitted light to a curing object.

2. The apparatus of claim 1 further including
a. a handheld body for portable control;
b. a mounting head for said LED source;
c. a lens mount for said Frensnel lenses;
d. a lens cap for shielding emitted curing light.

3. The apparatus of claim 2, wherein said handheld body comprising
a. a plurality of rechargeable batteries;
b. a plurality of circuit boards;
c. means of activating said circuit boards.

4. The apparatus of claim 3, wherein said handheld body is shaped from the selected group of cylindrical tube and elongated sphere with a main axis along a longitudinal handheld direction.

5. The apparatus of claim 1, wherein said LED source is a high power semiconductor diode and emit curing light with optical power approximately between 100 to 800 mW at a wavelength approximately between 300 to 500 nm.

6. The apparatus of claim 1, wherein said LED source mounted inside said mounting head and projecting at an angle approximately between 5 to 45 degrees from said main axis of said handheld body.

7. The apparatus of claim 1, wherein said Fresnel lenses comprising
a. a collimating lens with a focal length approximately between 2 to 10 millimeters to collect and collimate the curing light;
b. a plurality of Fresnel lenses that focus said collimated curing light to said object.

8. The apparatus of claim 1, wherein said Fresnel lenses are made from materials selected from the group consisting of polycarbonate, acrylic, rigid vinyl, and polyacrylic.

9. The apparatus of claim 2, wherein said circuit board comprising
a. a constant current circuit to drive said LED;
b. a timing circuit to control timing sequence of curing exposure;
c. a protection circuit to prevent overheating of said LED and circuit board.

10. The apparatus of claim 2, wherein said means of activating said circuit board comprising mechanical switches and liquid crystal control panels.

11. A method of making a dental LED curing light apparatus comprising the step of:
a. supplying a single LED source;
b. supplying means of powering up said LED source to emit curing light;
c. supplying a plurality of Fresnel lenses to collimate and focus said curing light.

12. The method of claim 12, wherein said LED source is a high power semiconductor diode and emit curing light with optical power approximately between 100 to 800 mW at a wavelength approximately between 400 to 500 nm.

13. The method of claim 12, wherein said means of powering up said LED source comprising the steps of:
a. supplying a plurality of rechargeable batteries as power supply;
b. supplying a plurality of circuit boards;
c. supplying means of activating said circuit boards.

14. The method of claim 12, wherein said Fresnel lenses comprising
a. a collimating lens with a focal length approximately between 2 to 10 millimeters to collect and collimate said curing light;
b. a plurality of Fresnel lenses that focus said collimated curing light to said curing object.

15. The method of claim 12, wherein said Fresnel lenses are made from materials selected from the group consisting of polycarbonate, acrylic, rigid vinyl, and polyacrylic.

16. The method of claim 14, wherein said said circuit board comprising
a. a constant current circuit to drive said LED;
b. a timing circuit to control timing sequence of curing exposure;
c. a protection circuit to prevent overheating of said LED and circuit board.

17. An optical apparatus for focusing curing light emitted from a LED source of a dental instrument comprising a plurality of Fresnel lenses.

18. The optical apparatus of claim 18, wherein said Fresnel lens has a first flat side and a second groove side.

19. The optical apparatus of claim 18, wherein said Fresnel lenses have thickness approximately between 0.1 to 2 millimeters.

20. The optical apparatus of claim 18, wherein said Fresnel lenses comprising:
a. a collimating lens with a focal length approximately between 2 to 10 millimeters to collect and collimate said emitted curing light;
b. a plurality of Fresnel lenses that focus said collimated curing light to a curing object.
